(19) United States
(12) Patent Application Publication
(10) Pub. No.: US 2026/0287455 A1
(43) Pub. Date: Sep. 24, 2026

(54) PRESSURE SENSOR

(71) Applicant: Kistler Holding AG, Winterthur (CH)

(72) Inventor: Christian HEER, Winterthur (CH)

(21) Appl. No.: 19/574,506

(22) Filed: Mar. 23, 2026

(30) Foreign Application Priority Data
Mar. 24, 2025 (EP) 25165560.1

(51) Int. Cl. G01L 9/00

(52) U.S. Cl. CPC G01L 9/0052; G01L 9/0048

(57) ABSTRACT

A pressure sensor for installation in a bore of a pressure chamber in a pressure-tight manner to measure the pressure of the medium inside the chamber includes a mounting body, a front housing part, and a measuring unit. The front housing part includes a diaphragm disposed remotely from the pressure chamber and operatively connected to the measuring unit to receive the pressure to be measured and to transmit the received pressure to the measuring unit. When the pressure sensor is in the mounted state, the front housing part includes a front region that rests against a wall of the pressure chamber. The front housing part includes a joint element that has a thickness at least a factor of 2 smaller than the thickness of the front region.

### TECHNICAL FIELD

The invention relates to a pressure sensor configured to be mounted in a measuring bore of a wall of a pressure chamber for measuring the pressure of a fluid medium constrained in the chamber.

### BACKGROUND OF THE INVENTION

The document WO2023/217465A1 discloses a sensor for measuring the pressure of a medium. Said pressure sensor comprises a diaphragm, a housing, and a measuring unit. The diaphragm and the housing enclose a cavity, and the measuring unit is arranged in the cavity. The diaphragm is configured to deform under the effect of pressure. Said diaphragm and the measuring unit are in operative connection. The measuring unit is configured to generate a measurement signal for the force resulting from the deformation of the diaphragm.

The pressure of the medium can be up to 2500 bar. Such a high pressure is usually achieved in a pressure chamber. To measure the pressure, the pressure sensor is mounted in a measuring bore in a wall of the pressure chamber. For this purpose, the pressure sensor of WO2023/217465A1 comprises a mounting body. The mounting body is configured to mount the pressure sensor on the wall of the pressure chamber. When the pressure sensor is in the mounted state, said diaphragm protrudes into the measuring bore. Thus, the diaphragm is in direct contact with the medium.

In order to prevent the highly pressurized medium from escaping from the pressure chamber through the measuring bore, which would pose a safety risk to people outside said pressure chamber, the housing of the pressure sensor of WO2023/ 217465A1 is also configured to protrude into the measuring bore and seal the measuring bore against an escape of the medium outside the pressure chamber by resting against the wall of the pressure chamber.

When the pressure sensor is mounted at the wall, mechanical stresses occur and act on the measuring unit via the housing from the mounting body. When the pressure sensor is measuring the pressure, the pressure from the mounting body can interfere with the force resulting from the deformation of the diaphragm and thus distort the measurement signal.

### OBJECTS AND SUMMARY OF THE INVENTION

It is therefore the object of the present invention to minimize, in a structurally simple and cost-effective manner, the influence on the measuring unit of mechanical stresses resulting from the mounting of the pressure sensor of WO2023/217465A1 as well as possible damage resulting from differences in coefficients of thermal expansion between components of the sensor. When different components have different coefficients of thermal expansion, operating at elevated temperatures can damage one or more components of the sensor.

These object are solved by the features described below.

The invention relates to a pressure sensor for measuring the pressure of a medium in a pressure chamber, which pressure chamber comprises a wall and a measuring bore, which pressure is applied in the measuring bore. The sensor includes a mounting body, a front housing part, and a measuring unit aligned along a longitudinal axis defined within the sensor. The mounting body is configured to mount the pressure sensor on the wall of the pressure chamber. The front housing part includes a front region close to the pressure chamber and a diaphragm unit remote from the pressure chamber with respect to the longitudinal axis of the pressure sensor. When the pressure sensor is in the mounted state on the pressure chamber, the front region rests against the wall in a pressure-tight manner, and the diaphragm unit becomes exposed to the pressure of the medium at the measuring bore. The diaphragm unit is configured to receive the pressure to be measured and to transmit that pressure to the measuring unit, which is configured to generate at least one measurement signal under the effect of the pressure. The front housing part includes at least one joint element that is arranged between the front region and the diaphragm unit with respect to the longitudinal axis of the pressure sensor. The thickness of the joint element is at least a factor of 2 smaller than the thickness of the front region.

The joint element in the front housing part according to the invention enables targeted influencing of the mechanical stresses originating from the mounting of the pressure sensor on the wall of the pressure chamber, which mechanical stresses are transmitted to the front housing part via the pressure-tight contact of the pressure sensor on the wall. Due to the smaller thickness of the joint element compared to the front region, the stiffness of the front housing part is locally reduced and is thus susceptible to deformation that absorbs stresses rather than transmitting those stresses.

The stiffness is a measure of the mechanical resistance of the front housing part to elastic deformation. The stiffness depends on the material of the front housing part, the processing of the material of the front housing part, and the geometry of the front housing part.

Thus, the stiffness of the front housing part can be adjusted via the thickness of the joint element so that the mechanical stresses elastically deform the joint element in a targeted manner and thereby largely compensate each other. As a result, the mechanical stresses can only act on the measuring unit via the diaphragm unit in a greatly attenuated magnitude and thus do not distort the measurement signal. In the context of the invention, the adjective "largely" has the meaning of greater than or equal to 90%.

Advantageous embodiments of the invention are explained more fully below.

### BRIEF DESCRIPTION OF THE DRAWINGS

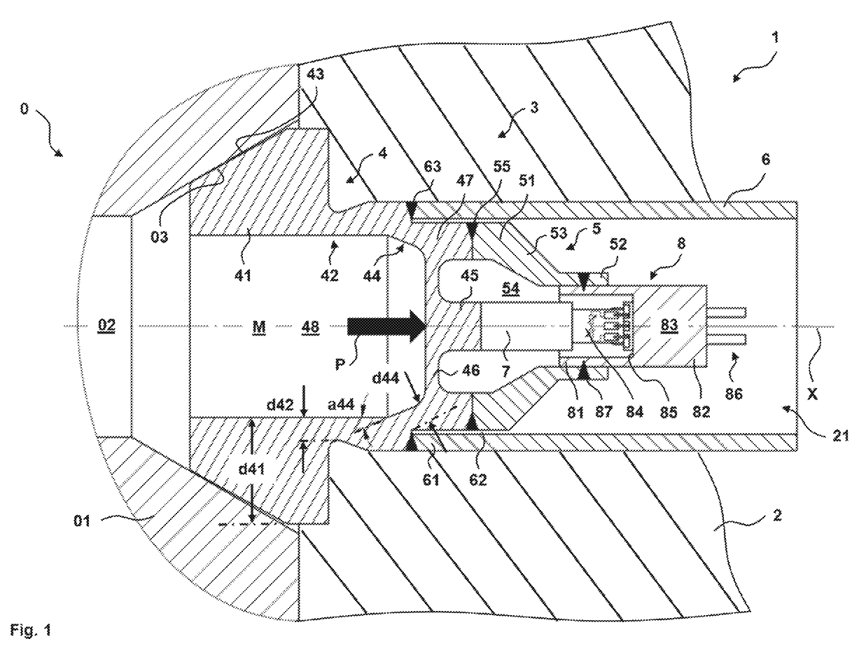

In the following, the invention is explained in more detail with reference to the single FIG. 1.

### DETAILED DESCRIPTION OF EXEMPLARY EMBODIMENTS OF THE INVENTION

FIG. 1 shows a cross-section through part of a pressure sensor 1 according to the invention for measuring a pressure P. The cross-section is taken along a longitudinal axis X of said pressure sensor 1. Hereinafter, a direction parallel to the longitudinal axis X is referred to as the longitudinal direction. A direction perpendicular to the longitudinal axis X is referred to as the radial direction.

Said pressure sensor 1 comprises a mounting body 2, a housing 3, and a measuring unit 8.

### The Pressure Chamber 0

The pressure P originates from a fluid medium M. According to FIG. 1, said medium M is located in a pressure chamber 0. The pressure chamber 0 is defined by a wall 01 made of a resistant metallic material such as high-alloy stainless steel. The wall 01 is pressure-tight. In the sense of the invention, the adjective "pressure-tight" means that the medium M cannot escape through the wall 01 to the outside of the pressure chamber 0. The pressure chamber 0 can be a storage container for the medium M, a compressor for the medium M, and the like.

The medium M can be gaseous and/or liquid. The medium M can contain hydrogen. In the context of the invention, the medium M contains hydrogen as soon as its hydrogen content is greater than or equal to 1 vol%. The pressure P is less than or equal to 2500 bar.

To measure the pressure P, the wall 01 defines a measuring bore 02. The measuring bore 02 is a through-hole which extends in the longitudinal direction from inside the pressure chamber 0 to outside the pressure chamber 0.

### The Mounting Body 2

The pressure sensor 1 includes a mounting body 2. The mounting body 2 is configured to perform the function of mounting the pressure sensor 1 on the wall 01 of the pressure chamber 0.

The mounting body 2 consists of a corrosion-resistant metallic material such as high-alloy stainless steel. The mounting body 2 is hollow and cylindrical in shape with an interior space 21 arranged in the region of the longitudinal axis X. The mounting body 2 surrounds the interior space 21 in radial direction. The mounting body 2 is configured to form a mechanical connection with the wall 01. Preferably, the mechanical connection is a screw connection. In FIG. 1, said screw connection is not shown in the figures. Preferably, the mounting body 2 is made in one piece. Preferably, the mounting body 2 is designed as a union nut.

### The Housing 3

The pressure sensor 1 includes a housing 3. The housing 3 also consists of a corrosion-resistant metallic material such as high-alloy stainless steel.

The housing 3 is arranged in the interior space 21 of the mounting body 2. Said pressure sensor 1 is mounted on the wall 01 of the pressure chamber 0 by forming the mechanical connection of the mounting body 2 with the wall 01.

The housing 3 includes a front housing part 4, an inner housing part 5, and an outer housing part 6. According to FIG. 1, the front housing part 4 is arranged along the longitudinal direction at an end of the pressure sensor 1 close to the pressure chamber, while the inner housing part 5 and the outer housing part 6 are arranged along the longitudinal direction at an end of the pressure sensor 1 remote from the pressure chamber 0.

### The Front Housing Part 4

The front housing part 4 is configured to perform the primary function of sealing the measuring bore 02. The front housing part 4 also is configured to perform the function of absorbing the pressure P to be measured and transmitting that pressure P to the measuring unit 8.

The front housing part 4 is pot-shaped that is cylindrical, open at one end and closed at the opposite end with a rim of the pot at the open end disposed close to the pressure chamber and a bottom of the pot defining the closed end that is disposed remote from the pressure chamber. At the rim of the pot, said front housing part 4 further defines a front region 41. At the bottom of the pot, the front housing part 4 defines a diaphragm unit 45, 46, 47. The front housing part 4 is made in one piece. A wall of the pot extends along the longitudinal axis x between the rim and the bottom. The wall of the pot includes at least one joint element 42, 44. According to FIG. 1, the wall and the bottom of the pot are closed and without openings. Only the rim of the pot exhibits an axial opening. The axial opening does not have any reference numeral. The rim, the wall, and the bottom of the pot enclose a cavity 48 of the front housing part 4. When the pressure sensor 1 is in the mounted state, the cavity 48 faces the pressure chamber 0. When the pressure sensor 1 is in the mounted state, the cavity 48 is accessible in the longitudinal direction from the measuring bore 02 through the axial opening. When the pressure sensor 1 is in the mounted state, the cavity 48 is filled with the medium M, and thus the pressure P is applied in the cavity 48.

When the pressure sensor 1 is in the mounted state, the front housing part 4 with the front region 41 rests against the wall 01. The front region 41 is defined by a thickness d41 measured in the radial direction with respect to the longitudinal axis X. The front region 41 and the wall 01 are configured in such a way that contact is made via a contact surface 43 of the front region 41 extending at an angle to the longitudinal direction and a contact surface 03 of the wall 01 extending at an angle to the longitudinal direction. Preferably, the contact surface 43 of the front region 41 and the contact surface 03 of the wall 01 are arranged at a constant radial distance from the longitudinal direction and in an annular shape around the measuring bore 02 such that the contact surface 43 defines a truncated cone. According to FIG. 1, the contact surface 43 of the front region 41 is arranged on a side of the front housing part 4 facing away from the cavity 48. Preferably, the contact surface 43 of the front region 41 and the contact surface 03 of the wall 01 are conical in shape, wherein the contact surface 43 of the front region 41 has a smaller opening angle than the contact surface 03 of the wall 01.

The mechanical connection of the mounting body 2 to the wall 01 is achieved by means of a mounting force. The mounting force causes the contact surface 43 of the front region 41 to rest against the contact surface 03 of the wall 01 in an annular, pressure-tight manner when the pressure sensor 1 is in the mounted state, and seals the measuring bore 02 against the escape of the medium M outside the pressure chamber 0.

When the pressure sensor 1 is in the mounted state, the diaphragm unit 45, 46, 47 is configured and disposed so as to become in communication with the measuring bore 02. The diaphragm unit 45, 46, 47 of the front housing part 4 includes a protrusion element 45, an elastic region 46, and an edge region 47. The diaphragm unit 45, 46, 47 is made in one piece.

The elastic region 46 is formed in an annular shape around the protrusion element 45 at a constant distance in the radial direction. The edge region 47 is also formed in an annular shape at a constant distance in the radial direction around the elastic region 46. Thus, the protrusion element 45, the elastic region 46, and the edge region 47 are concentrically disposed around the longitudinal axis X.

The protrusion element 45 is a thickening of the material of the front housing part 4 when measured along the longitudinal axis X. The elastic region 46 is a thinning of the material of the front housing part 4 when measured along the longitudinal axis X. The edge region 47, in turn, is a thickening of the material of the front housing part 4 when measured along the longitudinal axis X. Comparatively, the thickness of the elastic region 46 in the longitudinal direction is at least a factor of 2 smaller than the thickness of the protrusion element 45 or the thickness of the edge region 47. Due to its comparatively smaller thickness dimension, the elastic region 46 has a lower stiffness than the protrusion element 45 or the edge region 47.

The diaphragm unit 45, 46, 47 absorbs the pressure P to be measured by a displacement of the protrusion element 45 relative to the edge region 47 as accommodated by an elastic distortion of the elastic region 46. According to FIG. 1, the pressure P is schematically represented as an arrow acting along the longitudinal axis X on the protrusion element 45. Under the effect of the pressure P, the elastic region 46 allows a displacement for the protrusion element 45 in the longitudinal direction due to its comparatively thinner thickness. By said displacement, the pressure P is accommodated. The pressure P is transmitted along the longitudinal axis X via the displacement of the protrusion element 45 to the measuring unit 8.

The joint element 42, 44 is arranged in the longitudinal direction between the front region 41, which is disposed close to the pressure chamber, and the diaphragm unit 45, 46, 47, which is disposed remote from the pressure chamber. The joint element 42, 44 is a material thinning of the front housing part 4 as measured generally in the radial direction. Preferably, the front housing part 4 defines a first joint element 42 and a second joint element 44. The first joint element 42 is defined by a first thickness d42 measured in the radial direction. The second joint element 44 is defined by a second thickness d44 measured at an angle a44 relative to the longitudinal direction. Preferably, the angle a44 is in the range of 5° to 60°, preferably in the range of 10° to 45°, preferably in the range of 15° to 30°.

Preferably, the first thickness d42 of the first joint element 42 in the radial direction is at least a factor of 2 times smaller than the thickness d41 of the front region 41. Preferably, the second thickness d44 of the second joint element 44 when measured at an angle a44 relative to the longitudinal direction is at least a factor of 2 times smaller than the thickness of the front region 41 measured in the radial direction. Preferably, the first thickness 42 measured in the radial direction and the second thickness 44 measured at an angle a44 relative to the longitudinal direction are largely equal in size.

The stiffness of the front housing part 4 can be adjusted via the thickness of the joint element 42, 44 such that mechanical stresses originating from the mechanical connection of the mounting body 2 to the wall 01 and which are transmitted to the front housing part 4 via the pressure-tight contact of the pressure sensor 1 to the wall 01, cause the joint element 42, 44 to deform elastically in a targeted manner and thereby largely compensate for each other. As a result, the mechanical stresses only have a greatly reduced effect on the measuring unit 8 via said diaphragm unit 45, 46, 47 and therefore cannot distort the measuring signal generated by the measuring unit 8. Increasing the first thickness d42 increases the stiffness of the front housing part 4. Reducing the angle a44 reduces the stiffness of the front housing part 4.

### The Inner Housing Part 5

The inner housing part 5 is configured to perform the function of accommodating the measuring unit 8.

According to FIG. 1, the inner housing part 5 is hollow and cylindrical in shape. The inner housing part 5 is arranged on a side of the front housing part 4 facing away from the pressure chamber 0. The inner housing part 5 defines a proximal inner housing end 51 disposed close to the pressure chamber and a distal inner housing end 52 disposed spaced apart from the proximal inner housing end 51 remote from the pressure chamber in the longitudinal direction. The inner housing part 5 includes an inner housing wall 53. In the longitudinal direction, the inner housing part 5 delimits a cavity 54 between the proximal inner housing end 51 close to the pressure chamber and the distal inner housing end 52 remote from the pressure chamber. In the radial direction, the inner housing part 5 delimits the cavity 54 with the inner housing wall 53.

At the proximal housing end 51 close to the pressure chamber, the inner housing part 1 defines an axial opening. The cavity 54 is accessible in the longitudinal direction through the axial opening. The measuring unit 8 is arranged in the cavity 54.

An outer diameter of the inner housing part 5 is largely the same size measured in the radial direction as an outer diameter of the edge region 47 of the diaphragm unit of the front housing part 4.

The inner housing part 5 is fastened to the edge region 47 of the front housing part 4 with its proximal inner housing end 51 close to the pressure chamber via a first material-bonded connection 55. Preferably, the first material-bonded connection 55 is configured as a weld seam running circumferentially around the longitudinal axis X.

With knowledge of the present invention, a person skilled in the art can also manufacture the front housing part 4 and the inner housing part 5 as one piece.

### The Outer Housing Part 6

The outer housing part 6 is configured to perform the function of separating the inner housing part 5 from the mounting body 2 by means of an annular gap 62 extending along the longitudinal axis X.

According to FIG. 1, the outer housing part 6 is a tubular structure that is hollow and cylindrical in shape. The outer housing part 6 is arranged on a side of the front housing part 4 facing away from the pressure chamber 0 in the direction of the longitudinal axis X. The outer housing part 6 defines an outer housing end 61 disposed in the longitudinal direction close to the pressure chamber. In the radial direction, the inner diameter of the outer housing part 6 is greater than the outer diameter of the inner housing part 5. The inner diameter of the outer housing part 6 is also greater than the outer diameter of the edge region 47 of the diaphragm unit of the front housing part 5 measured in the radial direction.

The outer housing part 6 is fastened with its outer housing end 61 close to the pressure chamber via a second material-bonded connection 63 to at least one joint element 42, 44 of the front housing part 4. Preferably, the second material-bonded connection 63 is configured as a weld seam running circumferentially around the longitudinal axis X.

The outer diameter of the inner housing part 5 and the inner diameter of the outer housing part 6 are configured in such a way that, after the formation of the first material bond 55 and the second material bond 63, the annular gap 62 extending in longitudinal direction is formed as an empty annular space. The annular gap 62 is formed in the radial direction between the inner diameter of the outer housing part 6 and the outer diameter of the inner housing part 5. The annular gap 62 largely prevents mechanical stresses originating from the mechanical connection of the mounting body 2 to the wall 01 from being transmitted to the measuring unit 8 via the outer housing part 6 when the pressure sensor 1 is in the mounted state.

### The Transmission Element 7

The pressure sensor 1 includes a transmission element 7. The transmission element 7 is configured to perform the function of transmitting the pressure P from the protrusion element 45 to the measuring unit 8. Said transmission element 7 also is configured to perform the function of mitigating differences in the thermal expansion coefficients of the material of the housing 3 and the material of the measuring unit 8.

The transmission element 7 is made of a corrosion-resistant metallic material such as high-alloy stainless steel, and the like. The transmission element 7 desirably is solid and cylindrical in shape.

The pressure P to be measured can exhibit local pressure peaks which are significantly greater than the pressure P of the medium and which are locally limited to the protrusion element 45 and typically are transitory in nature. In order to prevent the pressure peaks from reaching the measuring unit 8 in an unhindered manner from the protrusion element 45 and causing an undesirable breakage of the measuring unit 8, the transmission element 7 is arranged in the cavity 54 on the longitudinal axis X between the protrusion element 45 and the measuring unit 8. Pressure peaks thus pass from the protrusion element 45 into the transmission element 7 and are transmitted over the length of the transmission element 7 to the measuring unit 8. In the process of being transmitted over the longitudinal length of the transmission element, the pressure peaks expand and dissipate to a harmless magnitude.

The pressure sensor 1 is configured for use at temperatures of up to 350° C. The housing 3 typically is formed of material having a coefficient of thermal expansion of around 7.7*10⁻⁶ K⁻¹ in the range of 20° C to 350° C, which coefficient of thermal expansion is stable in this temperature range. The measuring unit 8 typically is formed of a wider variety of materials, and thus there’s a wider variety coefficients of thermal expansion to be taken into account. For the materials of the measuring unit 8, at zero degrees Celcius, coefficients of thermal expansion are in a range of 7.10*10-6 per degree Celcius to 13.24*10-6 per degree C. However, at 400° C the coefficients of thermal expansion for the materials in the measuring unit 8 can be in a range of around 10.65*10-6 per degree C. to 18.5*10-6 per degree C. Thus, the coefficients of thermal expansion for the materials in the measuring unit 8 are more prone to vary with the temperature. Nonetheless, at such high temperatures reaching 350° C, the differences between the thermal expansion coefficients of the material of the housing 3 and the material of the measuring unit 8 generates thermal stress, which can produce undesirable damage to the pressure sensor 1. To attenuate this thermal stress, the material of the transmission element 7 is chosen to have a coefficient of thermal expansion that is greater in magnitude than the coefficient of thermal expansion of the material of the housing 3 and that of the material of the measuring unit 8.

### The Measuring Unit 8

The measuring unit 8 is configured to perform the function of generating at least one measurement signal indicative of the magnitude of the pressure P to be measured.

The measuring unit 8 is defined by a proximal end 81 disposed close to the pressure chamber 0 and a distal end 82 disposed spaced apart from the proximal end 81 and remote from the pressure chamber 0 in the longitudinal direction X.

The measuring unit 8 includes a supporting sleeve 83 and a measuring circuit 84.

According to FIG. 1, the supporting sleeve 83 is partially hollow and cylindrical in overall form. The supporting sleeve 83 is made of a corrosion-resistant metallic material such as high-alloy stainless steel, and the like. Preferably, said supporting sleeve 83 is manufactured in one piece.

The supporting sleeve 83 is configured to perform the function of housing and protecting the measuring circuit 84 in the hollow portion of the supporting sleeve 83 and supporting the measuring circuit 84 in the solid portion of the measuring sleeve 83.

The measuring circuit 84 is configured to operate according to any of various conventional measuring principles.

Preferably, the measuring circuit 84 operates according to the piezoresistive measuring principle. For this purpose, the measuring circuit 84 includes a supporting body with electrical resistance elements and contacting sites. The electrical resistance elements and the contacting sites are electrically connected by electrical conductor elements. Preferably, the measuring circuit 84 is configured to form a Wheatstone bridge circuit. Preferably, the supporting body is an SOI (silicon-on-insulator). Preferably, the contacting sites of the measuring circuit 84 include two first contacting sites and two second contacting sites. When an operating voltage is applied to the two first contacting sites, then the pressure P applied to the measuring circuit 84 causes a change in resistance, which change in resistance produces a change in voltage that can be tapped as a measurement signal at the two second contacting sites.

However, the measuring circuit 84 can also operate according to the piezoelectric measuring principle. For this purpose, the measuring circuit 84 includes piezoelectric material such as SiO₂, GaPO₄ and the like, and electrodes made of electrically conductive material such as high-alloy stainless steel, and the like. Under the effect of the pressure P applied to the measuring circuit 84, the piezoelectric material generates electrical charges which can be tapped from the electrodes as a measurement signal.

The supporting sleeve 83 includes a support body 85. According to FIG. 1, the support body 85 is arranged in the region of the longitudinal axis X on the support sleeve 83. The supporting body of the measuring circuit 8 rests against the support body 85 of the supporting sleeve 83. Under the effect of the pressure P applied to the measuring circuit 84, the support body 85 absorbs an equal counterforce from the measuring circuit 84.

The measuring unit 8 includes a feedthrough 86 at its distal housing end 82 remote from the pressure chamber 0. The feedthrough 86 includes several pin elements. The pin elements are made of electrically conductive material such as copper, silver, gold, and the like. The pin elements do not have any reference numerals. The feedthrough 86 includes an insulating element. The insulating element consists of electrically insulating material such as aluminum oxide, ceramic, sapphire, and the like.

The pin elements are embedded in the insulating element. The pin elements are fastened to the supporting sleeve 83 at the distal end 82 of the supporting sleeve 83 remote from the pressure chamber 0 via the insulating element. Preferably, the insulating element is fastened to the supporting sleeve 83 via a material-bonded connection such as a soldered connection, and the like. The material-bonded connection is not shown in the figure. The pin elements embedded in the insulating element are thus fastened in the supporting sleeve 83 and electrically insulated from the supporting sleeve 83.

The measuring unit 8 includes a plurality of conventional conductor elements made of electrically conductive material such as copper, silver, gold, and the like. Each of the plurality of conductor elements is wire-shaped. The conductor elements electrically connect the contacting sites of the measuring circuit 84 to the pin elements of the feedthrough 86. Preferably, each of the contacting sites of the measuring circuit 84 is electrically connected via a conductor element to exactly one of the pin elements of the feedthrough 86. The conductor elements are not given any reference numerals in FIG. 1.

The measuring unit 8 is attached to the supporting sleeve 83 via a third material-bonded connection 87 at the distal end 52 of the inner housing part 5 and thus remote from the pressure chamber 0. Preferably, the third material-bonded connection 87 of the supporting sleeve 83 is arranged at the proximal end 81 of the measuring unit 8 and thus close to the pressure chamber 0. Preferably, the third material-bonded connection 87 is configured as a weld seam running circumferentially around the longitudinal axis X.

According to FIG. 1, the third material-bonded connection 87 is arranged in such a way that the transmission element 7 and the measuring circuit 84 are mechanically clamped on the longitudinal axis X between the protrusion unit 45 of the front housing part 4 and the support body 85 of the measuring unit 8.

### LIST OF REFERENCE SYMBOLS

0 Pressure chamber

01 Wall

02 Measuring bore

1 Pressure sensor

2 Mounting body

21 Interior space

3 Housing

4 Front housing part

41 Front region

D41 Thickness

42 First joint element

D42 Thickness

43 Contact surface

44 Second joint element

a44 Angle

d44 Thickness

45 Protrusion element

46 Elastic region

47 Edge region

48 Cavity

5 Inner housing part

51 proximal Inner housing end

52 distal Inner housing end

53 Housing wall

54 Cavity

55 Second material-bonded connection

6 Outer housing part

61 Outer housing end close to the pressure chamber

62 Annular gap

63 Second material-bonded connection

7 Transmission element

8 Measuring unit

81 proximal End of measuring unit 8

82 distal End of measuring unit 8

83 Supporting sleeve

84 Measuring circuit

85 Support body

86 Feedthrough

87 Third material-bonded connection

M Medium

P Pressure

X Longitudinal axis

What is claimed is:

1. A pressure sensor for measuring the pressure of a medium in a pressure chamber that includes a wall defining a measuring bore that is configured to receive the pressure of the medium, the pressure sensor comprising:
a mounting body configured to mount the pressure sensor on the wall of the pressure chamber;
a front housing part that defines a generally cylindrical shape that elongates along a longitudinal axis between a front region and a diaphragm unit, wherein the front region defines an opening into a hollow interior that is closed by the diaphragm unit, wherein the front region defines an exterior configured to rest against the wall in a pressure-tight manner; and
a measuring unit configured to generate at least one measurement signal under the effect of the pressure;
wherein the diaphragm unit is configured and disposed to receive the pressure to be measured and to transmit the pressure to be measured to the measuring unit; and
wherein the front housing part defines a joint region disposed along the longitudinal axis between the front region and the diaphragm unit, wherein the joint region is defined by a thickness measured in a radial direction from the longitudinal axis, wherein the thickness of the joint region is at least half of a thickness of the front region measured in a radial direction from the longitudinal axis.

2. The pressure sensor according to claim 1, wherein the joint element is configured to deform elastically in a manner that absorbs mechanical stresses acting on the front housing part from the pressure-tight connection of the pressure sensor to the wall of the pressure chamber in the mounted state of the pressure sensor.

3. The pressure sensor according to claim 1, wherein the joint element includes a first joint element that defines a first thickness measured along a radial direction that is perpendicular to the longitudinal axis.

4. The pressure sensor according to claim 3, wherein the front housing part is defined by a stiffness, and an increase in the first thickness increases the stiffness of the front housing part.

5. The pressure sensor according to claim 1, wherein the joint element includes a second joint element that defines a second thickness at an angle relative to the longitudinal axis.

6. The pressure sensor according to claim 5, wherein the angle is in the range from 15° to 30°.

7. The pressure sensor according to claim 5, wherein the angle is in the range from 10° to 45°.

8. The pressure sensor according to claim 5, wherein the angle is in the range from 5° to 60°.

9. The pressure sensor according to claim 5, wherein the magnitude of the stiffness of the front housing part is variable in direct proportion to the magnitude of the angle.

10. The pressure sensor according to claim 1, wherein the front housing part is configured in the shape of a pot enclosing a cavity open at an end thereof;
wherein the front region forms a rim of the pot at the open end of the cavity;
wherein the diaphragm unit forms a bottom of the pot disposed spaced apart from the open end of the cavity along the longitudinal axis;
wherein the joint element forms a wall of the pot extending along the longitudinal axis between the bottom and the rim; and
wherein when the pressure sensor is in the mounted state, the cavity faces the pressure chamber and is accessible from the measuring bore to be filled with the medium in which the pressure is applied from the pressure chamber.

11. The pressure sensor according to claim 10, wherein the front region of the front housing part defines a contact surface extending obliquely to the longitudinal axis and disposed on a side of the front housing part facing away from the cavity of the front housing part;
wherein when the pressure sensor is in the mounted state, the wall of the pressure chamber defines a contact surface extending at an angle to the longitudinal axis; and
wherein a mounting force is responsible for the contact surface of the front region resting against the contact surface of the wall in a pressure-tight manner.

12. The pressure sensor according to claim 1, wherein the diaphragm unit includes a protrusion element, an elastic region, and an edge region;
wherein the elastic region is formed in a radial direction perpendicular to the longitudinal axis at a constant distance in an annular shape around said protrusion element;
wherein the edge region is formed in a radial direction perpendicular to the longitudinal axis at a constant distance around the elastic region in an annular shape;
wherein a thickness of the elastic region measured along the longitudinal axis is at least a factor of 2 smaller than a thickness of the protrusion element or a thickness of the edge region; and
wherein when the pressure sensor is in the mounted state, the thickness of the elastic region is deformable along the longitudinal axis under the pressure in the pressure chamber.

13. The pressure sensor according to claim 12, further comprising an inner housing part that is hollow cylindrical in shape and defining an outer diameter;
wherein when said pressure sensor is in the mounted state, the inner housing part is arranged on a side of the front housing part facing away from the pressure chamber; and
wherein the inner housing part delimits a cavity in which the measuring unit is arranged.

14. The pressure sensor according to claim 13, wherein the inner housing part includes an inner housing end disposed close to the pressure chamber; and wherein the inner housing part is fastened to the front housing part at the edge region by means of a first material-bonded connection at the inner housing end.

15. The pressure sensor according to claim 13, further comprising an outer housing part that is hollow and cylindrical in shape and defines an inner diameter;
wherein when said pressure sensor is in the mounted state, the outer housing part is arranged on a side of the front housing part facing away from the pressure chamber;
wherein in a radial direction perpendicular to the longitudinal axis, the inner diameter of the outer housing part is greater than the outer diameter of the inner housing part; and
wherein an annular gap is defined in the radial direction between the inner diameter of the outer housing part and the outer diameter of the inner housing part.

16. The pressure sensor according to claim 15, wherein the outer housing part defines an outer housing end close to the pressure chamber; and wherein the outer housing part is attached to the joint element of the front housing part via a second material-bonded connection at the outer housing end.

17. The pressure sensor according to claim 13, wherein the measuring unit includes a supporting sleeve and a measuring circuit;
wherein the inner housing part defines an inner housing end remote from the pressure chamber; and
wherein the measuring unit is fastened to the supporting sleeve via a third material-bonded connection at the housing end of the inner housing part remote from the pressure chamber.
